(19) United States
(12) Patent Application Publication
(10) Pub. No.: US 2025/0243414 A1
(43) Pub. Date: Jul. 31, 2025

(54) RENEWABLE BIOMASS FEED SLURRY HYDROPROCESSING

(71) Applicant: CHEVRON U.S.A. INC., San Ramon, CA (US)

(72) Inventors: Bo KOU, Albany, CA (US); Shuwu YANG, Richmond, CA (US); Julie CHABOT, Novato, CA (US); Theodorus Ludovicus Michael MAESEN, Spring, TX (US); Michelle K. YOUNG, Manvel, TX (US)

(21) Appl. No.: 18/853,343

(22) PCT Filed: Mar. 31, 2023
(86) PCT No.: PCT/IB2023/053233

§ 371 Date: Oct. 1, 2024

Related U.S. Application Data
(60) Provisional application No. 63/326,803, filed on Apr. 1, 2022.

(51) Int. Cl. C10G 1/08

(52) U.S. Cl. CPC C10G 1/086; C10G 2300/1011

(57) ABSTRACT

Renewable biomass feed slurry hydroprocessing is described, including, for example, a slurry hydroconversion process in which a feedstock comprising a renewable biomass component is subjected to slurry hydroconversion. The process generally comprises contacting a solid biomass feedstock and a slurry hydroconversion catalyst under suitable hydroconversion conditions to convert a portion of the feedstock to liquid and/or gas products. The process may utilize raw biomass as a feedstock and does not require the use of chemically processed or modified biomass feeds. Low coke yields may be obtained.

### CROSS REFERENCE TO RELATED APPLICATIONS

This application is related to and claims the benefit of priority to U.S. Provisional Patent Appl. Ser. No. 63/326,803 filed on 1 Apr. 2022, entitled “RENEWABLE BIOMASS FEED SLURRY HYDROPROCESSING”, the disclosure of which is herein incorporated in its entirety.

### FIELD OF THE INVENTION

The present disclosure relates to renewable biomass feed slurry hydroprocessing, including, for example, a slurry hydroconversion process in which a feedstock comprising a renewable biomass component is subjected to slurry hydroconversion.

### BACKGROUND OF THE INVENTION

The use of renewable resources has garnered significant attention and effort in the drive to develop fossil fuel alternatives. The variety, availability and versatility of various biomass materials has been of great interest, particularly certain lignocellulosics and other carbohydrates. The development and commercial use of bio-based fuel technology has not been as successfully implemented as hoped for, however, despite the promise and keen interest. While some biofuels technologies have been commercialized, so-called second generation renewable feedstocks have not been widely developed, particularly transportation fuels from second generation renewable biofuel feedstocks.

Renewable fuels (biofuels) are seen as being important to reduce carbon and greenhouse emissions. First-generation biofuels are fuels made from food crops grown on arable land, while second-generation biofuels are produced from lignocellulosic biomass or agricultural residues/waste. Unlike first gen biofuels from competing biomass food sources, second generation renewable fuels are not generally derived from human food sources and are therefore preferred over first generation renewable fuel. Typical second generation feedstocks include wood, grasses, algae, crop byproduct, municipal solid waste, and the like. Processing of second gen biomass, however, has typically required a more complicated two-step or multi-step process to convert the usable portion of solid biomass into a suitable feedstock. In particular, the first step is typically conversion of solid biomass feedstocks into a liquid biocrude form by pyrolysis, hydrolysis, hydrothermal liquefaction, or other process step. Upgrading of the biocrude is then typically further performed using conventional refinery units, e.g., a hydrotreater or FCC unit, to produce transportation fuel.

Other difficulties with prior technologies have resulted in fuels having a low energy density, such as bioethanol, or fuels such as methanol, biodiesel, hydrogen, and methane that not fully compatible with existing engine designs and transportation infrastructure, or produced dilute aqueous solutions that are not cost-effective to further process. It would be a significant advantage if a simplified process was provided for the direct use of solid biomass in a hydroconversion process for producing renewable fuels (or products useful to make renewable fuels) without the need for pre-processing of the solid biomass. The use of high biomass content feeds that minimize or eliminate the use of fossil fuel co-feeds is particularly desirable in light of global efforts to utilize methods that reduce fossil fuel use. It would be very desirable to provide a cost and energy efficient way of processing lignocellulosic biomass into renewable fuels having chemical compositions similar to fossil fuels in a manner that alleviates the foregoing concerns and problems.

### SUMMARY OF THE INVENTION

The present invention is generally directed to renewable biomass feed slurry hydroprocessing. In one aspect, a slurry hydroconversion process is provided in which a feedstock comprising a renewable biomass component is subjected to slurry hydroconversion. The process generally comprises contacting a solid biomass feedstock and a slurry hydroconversion catalyst under suitable hydroprocessing conditions to convert a portion of the feedstock to hydroconversion products (e.g., liquid and/or gas products). The process may utilize raw biomass as a feedstock and does not require the use of chemically processed or modified biomass feeds. Low coke yields may be obtained as one of the benefits associated with the process. While not necessarily limited thereto, one of the goals of the invention is to provide a simplified and effective process for making renewable fuels and/or other products from unprocessed biomass feedstocks.

In general, the process according to the invention comprises feeding a solid biomass feedstock, a liquid feedstock, and a slurry hydroconversion catalyst or a precursor thereof, to a slurry hydroconversion reactor; contacting the solid biomass feedstock and the liquid feedstock with the slurry hydroconversion catalyst for a sufficient time under hydroconversion process conditions in the presence of hydrogen to convert a portion of the solid biomass feedstock and the liquid feedstock to one or more hydroconversion products, such as liquid and/or gas products, and withdrawing hydroconversion product from the reactor. The solid biomass feedstock is typically directly fed to the slurry hydroconversion reactor and is provided as a raw biomass feedstock containing biomass components that have not been chemically processed or modified prior to being directly fed to the slurry hydroconversion reactor.

### BRIEF DESCRIPTION OF THE DRAWINGS

The scope of the invention is not limited by any representative figures accompanying this disclosure and is to be understood to be defined by the claims of the application.

FIG. 1 is a general block diagram schematic illustration of an embodiment according to the invention in which solid biomass feedstock is directly fed to a reactor and separated to provide solid biomass hydroconversion products.

### DETAILED DESCRIPTION

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Unless otherwise indicated, the following terms have the meanings as defined hereinbelow.

The term “hydroconversion” refers to processes or steps performed in the presence of hydrogen for the hydrocracking, hydrogenation, hydrodeoxygenation, hydrodesulfurization, hydrodenitrogenation, hydrodemetallation, hydrodechlorination, hydrodecarboxylation, hydrodecarbonylation and/or hydrodearomatization of components (e.g., impurities) of a hydrocarbon or biomass feedstock, and/or for the hydrogenation of unsaturated compounds in the feedstock. Depending on the type of hydroconversion and the reaction conditions, products of hydroconversion processes may have improved specific gravity, acidity, aromatic content, viscosities, viscosity indices, saturates content, low temperature properties, volatilities and depolarization, for example.

The term “catalyst support” is used in the conventional sense according to the normal usage in the art and includes typical catalyst support materials such as alumina, silica-alumina, metal oxides, zeolites and non-zeolite materials, activated carbon, and the like.

“Catalyst precursor” refers to a compound containing one or more catalytically active metals, from which compound the slurry catalyst is eventually formed, and which compound may be catalytically active as a hydroprocessing catalyst. An example is a water-based catalyst prior to a transformation step with a hydrocarbon diluent, another example is a sulfided metal precursor. Catalyst precursors and the preparation of slurry catalysts are described in various patents, e.g., U.S. Pat. No. 8,802,586, WO 2012/092006, and the like.

The term “raw biomass” is intended to refer to suitable biomass feedstocks that are not chemically processed or modified prior to being used in the process. Such chemically processed or modified biomass materials include, e.g., lignocellulosic materials that have been treated to remove or reduce the content of certain components, or chemically modify such components, such as the removal of cellulose or hemicellulose, or the modification of lignin. Other chemically modified biomass materials may include biomass materials that have been modified through torrefaction, or biomass treated using slow pyrolysis, fast or flash pyrolysis, hydrothermal liquefaction, hydropyrolysis, kraft processing, and the like. Raw biomass materials may include mechanically modified biomass materials or dried biomass materials. Thermally processed biomass materials may not be “raw biomass” materials within the context of the invention, however, when such biomass materials are chemically modified, including, e.g., pyrolysis products derived from biomass. Typical drying processes do not alter the biomass composition and only remove moisture and are therefore not chemical modifications.

The term “pore volume”, as used to describe the porosity of solid biomass, may be described in terms of the “wet pore volume” and the “pore volume” determined by mercury intrusion. The “incipient wet pore volume” or “wet pore volume” is measured by the incipient wetness impregnation method. In the method, an amount of dried biomass is impregnated with a liquid, typically water, by capillary action until all the biomass pores are saturated. The wet “pore volume” is calculated by dividing the total volume of water absorbed in the biomass pores by the total weight of the solid biomass. The mercury intrusion pore volume of the solid biomass is measured according to ASTM D4284, and is typically provided by a commercial mercury intrusion porosimeter.

The Periodic Table of the Elements referred to in this disclosure is the CAS version published by the Chemical Abstract Service in the Handbook of Chemistry and Physics, 72^{nd} edition (1991-1992).

Unless otherwise specified, the recitation of a genus of elements, materials, or other components from which an individual component or mixture of components can be selected is intended to include all possible sub-generic combinations of the listed components and mixtures thereof. Also, “include” and its variants are intended to be non-limiting, such that recitation of items in a list is not to the exclusion of other like items that may also be useful in the materials, compositions, and methods of this invention.

In the process of the invention, solid biomass feedstock and liquid feedstock are separately fed to the slurry hydroconversion reactor. The slurry catalyst may be separately fed or added to the reactor as a combination with the liquid feedstock. Hydrogen is also typically fed to the reactor and may be combined with any of the feeds or separately fed to the reactor. The slurry hydroconversion catalyst the liquid feedstock, and hydrogen may be pre-mixed in any combination or amount before being fed to the hydroconversion reactor. The slurry hydroconversion catalyst may be a precursor thereof.

The feeds to the hydroconversion reactor generally comprise at least about 10 wt. %, or 20 wt. %, or 30 wt. %, or 40 wt. %, or 50 wt. %, or 60 wt. % solid biomass, 0-40 wt. % liquid feedstock and less than about 5 wt. %, or less than about 2 wt. % or less than about 1 wt. %, slurry hydroconversion catalyst or a precursor thereof. One or more liquid hydrocarbon products and/or slurry catalyst may also be recycled to the hydroconversion reactor. In general, any suitable hydroconversion process conditions may be used. Typical hydroconversion process conditions include operation within a temperature range of about 650-950° F., a reactor pressure of about 300-3500 psig, an average residence time of 10 min. to 5 hrs., and a space velocity of about 0.1 to 5.0, or 0.5 to 5.0, or 0.5 to 2.0 hr⁻¹. Mixing within the reactor helps to improve solids dispersion and the reactor thermometry and may be accomplished using mechanical mixing (e.g., stirrers and impellers), liquid recirculation (e.g., pumps, thermal siphon), gas bubbling (e.g., bubble column reactor), and the like.

Among the advantages of the invention, is the ability to use solid biomass feedstock as a direct feed to a hydrocracker rather than chemically converting or modifying the biomass before using it as a direct hydrocracker feed. For example, the invention does not require the conversion of solid biomass to a liquid form such as biocrude before use. Other processes of modifying biomass before use in the process are also not necessary, such as, e.g., hydropyrolysis, hydrothermal carbonization, torrefaction, or the removal of certain carbohydrate components such as cellulose, hemicellulose, or lignin.

As compared with co-feeding of combined solid biomass and liquid feedstock, including as a dispersion or suspension, the direct injection of solid biomass according to the process also eliminates problems associated with the use of liquid co-feeds. Many biomass feedstocks, such as wood, grass and other agricultural products, are characterized by relatively low density and high pore volume, such that, when the biomass solids content reaches a certain range, e.g., 35-50 wt. %, liquid becomes trapped inside the solids leaving little to no free liquid. Essentially, the mixture of solid biomass and liquid results in wetted solids rather than a slurry, suspension, or dispersion. A limitation on the maximum biomass content in a solid biomass and liquid co-feed exists for such processes. With direct solid biomass injection, however, such a limitation is avoided and the total solid biomass content fed to a reactor (relative to any separate liquid feedstock provided to the reactor) can be much higher. Since operation of the reactor under slurry hydroconversion conditions requires enough liquid to keep the solids in a slurry, the combination of any separate liquid feedstock and liquid produced from the hydroconversion of solid biomass fed to the reactor allows for a higher content of solid biomass to be directly fed to the reactor.

Direct solid biomass injection allows for certain product benefits to be realized, including reduced coke yield, which is typically less than about 5 wt. %, or less than about 2 wt. %, or less than about 1 wt. % of the solid biomass fed to the process. The liquid product oxygen content may also be less than about 3 wt. % or less than about 1 wt. %, and/or the total acid number (TAN) may be less than about 1.

Other operational benefits associated with the direct feeding of solid biomass may include significantly reduced energy consumption due to the use of less liquid feedstock and the mitigation of biomass feedstock limitations imposed by slurry or liquid handling means (e.g., pumping) since direct solid injection allows for the handling of larger and more variably-sized biomass solids.

While not limited thereto, the process of the invention may be used to provide a renewable fuel or a product component useful to make a renewable fuel from the liquid and/or gas products derived from the process.

The solid biomass feedstock may comprise a solid biomass component selected from wood or wood mill byproduct, tree leaves, grass, algae, crop byproduct, municipal solid waste, or a combination thereof, optionally, wherein the solid biomass component is ground, pulverized, chipped or in a particulate, pellet, powder, shaving, chip, dust, or pulverized form, or a combination thereof. Transfer of the solid biomass to the hydroconversion reactor may be through a variety of single or combined means, including, e.g., the use of a pressure transfer vessel, extruders, a rotatory valve, or a lock hopper. Raw biomass materials can be crushed or otherwise treated to any desired size or size range, e.g., in the range of 50 microns to 10 mm, or into wood chips up to 3 cm in length, and the like. The raw biomass may be dried or in an undried condition.

In general, the solid biomass feedstock is provided as a raw biomass feedstock containing biomass components that have not been chemically processed or modified prior to being directly fed to the slurry hydroconversion reactor. For example, certain modified biomass materials such as lignin, e.g., from a papermaking process, are not intended to be included in the process, e.g., according to U.S. Pat. No. 8,795,472 B2.

The solid biomass feedstock fed to the slurry hydroconversion reactor may undergo various reactions, including hydrocracking, hydrogenation, hydrodeoxygenation, hydrodesulfurization, hydrodenitrogenization, hydrodemetallization, hydrodechlorination, hydrodecarboxylation, hydrodecarbonylation, hydrodearomatization or a combination thereof.

The liquid feedstock generally comprises a heavy boiling point component having a boiling point of at least about 800° F. For example, while not limited thereto, the liquid feedstock may typically be selected from vacuum gas oil, atmospheric resid, vacuum resid, FCC heavy cycle oil or decanted oil, FCC medium cycle oil, hydrocracker unconverted oil, or a combination thereof. The heavy boiling point component having a boiling point of at least about 800° F. may be present in the liquid feedstock in an amount of up to about 50 wt. %, or 40 wt. %, or 30 wt. %, or 20 wt. %, or 10 wt. %, or in the range from about 10-50 wt. %, or 10-40 wt. %, or 10-30 wt. %, or 20-30 wt. %. The liquid feedstock may comprise one or more components having a high boiling point of at least about 650° F., or 675° F., or 700° F., or 725° F., or 750° F. The amount of the liquid feedstock component having a high boiling point present in the liquid feedstock is at least about 10 wt. %, or 20 wt. %, or 30 wt. %, or 40 wt. %, or 50 wt. %, or 60 wt. %, or 70 wt. %, or 80 wt. %, or 90 wt. % of the liquid feedstock. The liquid feedstock may further comprise a renewable feedstock selected from plastic and/or wood pyrolysis oil, lipid, vegetable oil, or a combination thereof.

In addition, the liquid feedstock may be combined with a recycled slurry hydroconversion reactor product before being directly fed to the slurry hydroconversion reactor. All or part of any liquid product may also be recycled to the slurry hydroconversion reactor. Any recycled liquid product may first be processed to reduce or eliminate the solids present in the recycle, e.g., by solid-liquid separation of the hydroconversion reactor liquid product. Typical means for separating solids from liquids may be utilized, e.g., including but not limited to settling, sieving, filtration, or centrifugation.

The slurry hydroconversion catalyst is generally provided in the form of fine particulates dispersed within the reactor liquid reaction medium and may be a supported catalyst, an unsupported catalyst, or a combination thereof. The slurry catalyst typically comprises a metal selected from Group VIB, Group VIII, or Group IIB of the Periodic Table, or a combination thereof. The slurry hydroconversion catalyst may be unsulfided or pre-sulfided before being added to the reactor. The slurry catalyst may also be dispersed within a hydrocarbon oil diluent. A sufficient amount of slurry catalyst is typically fed to a slurry reactor(s) for each reactor to have a slurry catalyst concentration of from 100 wppm, or 300 wppm, or 500 wppm, up to about 3 wt. % (catalyst metal to feedstock ratio). The slurry catalyst can comprise one or more different slurry catalysts as a single combined feed stream or as separate feeds to the reactor.

In some cases, the slurry hydroconversion catalyst comprises an unsupported catalyst selected from molybdenum sulfide, iron sulfide, nickel sulfide, zinc sulfide, iron zinc, or a combination thereof. The slurry hydroconversion catalyst may also be provided in the form of a catalyst precursor selected from oil soluble Group VIB metal (e.g., molybdenum) compounds, aqueous Group VIB metal (e.g., molybdenum) compounds, aqueous Group VIB metal (e.g., molybdenum) trisulfide suspension or colloid, or a combination thereof. Still further, the slurry hydroconversion catalyst may comprise a supported catalyst wherein the support is selected from alumina, silica-alumina, transition metal oxides, activated carbon, zeolite, or a combination thereof.

Suitable slurry catalysts, slurry catalyst precursors, and the preparation of slurry catalysts are described in various patents, e.g., U.S. Pat. No. 8,802,586, WO 2012/092006, US 2015/0329790A1, and the like. For example, suitable catalysts used in slurry hydroprocessing systems may comprise at least one Group VIII metal (e.g., Ni and/or Co) most often in combination with at least one Group VIB metal (e.g., Mo) on a refractory inorganic oxide support such as alumina or silica. These supported catalysts generally contain from 0.5 to 10 wt. % of at least one Group VIII metal (calculated as metal oxide) and from 1 to 30 wt. % of the at least one Group VIB metal (calculated as metal oxide), and optionally with at least one Group IIB metal (e.g., Zn). Such supported catalysts are commonly produced as cylindrical pellets, spherical solids, or extrudates, and may be ground into fine powder for use as a slurry catalyst. In some cases, the slurry catalyst may be a multi-metallic catalyst comprising at least one Group VIII non-noble metal and at least two Group VIB metals, and wherein the ratio of the at least two Group VIB metals to the Group VIII non-noble metal is from 10:1 to 1:10.

The slurry catalyst may be of the formula (M^{t})ₐ(X^{u})_{b}(S^{v})_{d}(C^{w})ₑ(H^{x})_{f}(O^{y})_{g}(N^{z})ₕ, wherein M represents at least one Group VIB metal, such as Mo, W., etc., or a combination thereof, and X functions as a promoter metal, representing at least one of a non-noble Group VIII metal such as Fe, Ni, Co; a Group IVB metal such as Ti; a Group IIB metal such as Zn; and combinations thereof (X being a “Promoter Metal”). Superscripts t, u, v, w, x, y, and z represent the total charge for each of M, X, S, C, H, O and N, respectively; and wherein (ta+ub+vd+we+xf+yg+zh)=0. The subscript ratio of b to a has a value of from 0 to 5 (0≤b/a≤5). S represents sulfur with subscript d having a value of from (a+0.5b) to (5a+2b). C represents carbon with subscript e having a value of from 0 to 11 (a+b). H is hydrogen with subscript f having a value of from 0 to 7 (a+b). O represents oxygen with subscript g having a value of from 0 to 5 (a+b). N represents nitrogen with subscript h having a value of 0 to 0.5 (a+b). Subscript b has a value of 0 in some embodiments, e.g., for a single metallic component catalyst such as a Mo only catalyst and having no promoter.

The slurry catalyst may be prepared from catalyst precursor compositions including organometallic complexes or compounds, e.g., oil soluble compounds or complexes of transition metals and organic acids. Examples of such compounds include naphthenates, pentanedionates, octoates, and acetates of Group VIB and Group VIII metals. In some cases, the slurry catalyst may be prepared from ground or recovered supported hydroprocessing catalyst powder in oil.

The slurry catalyst may have an average particle size of at least 0.1-micron in a diluent. In one embodiment, the slurry catalyst has an average particle size of from 1 to 100 microns, e.g., from 2 to 10 microns. In some cases, the slurry catalyst particle may comprise aggregates of catalyst molecules and/or extremely small particles that are colloidal in size (i.e., less than 100 nm, less than about 10 nm, less than about 5 nm, or less than about 1 nm). In one embodiment, the slurry catalyst comprises aggregates of single layer MoS clusters of nanometer sizes, e.g., 5 to 10 nm on edge. The colloidal/nanometer sized particles may form aggregates in a hydrocarbon diluent forming a slurry catalyst with an average particle size of from 1 to 20 microns.’

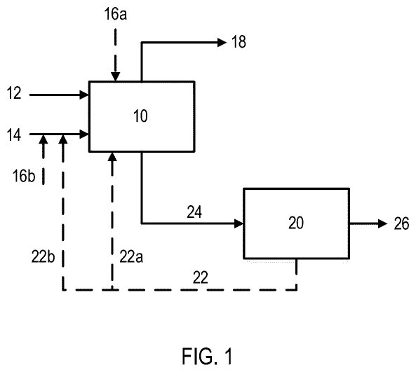

A block process schematic according to an embodiment of the invention is shown in FIG. 1. Hydroconversion reactor 10 is separately fed with solid biomass feedstock 12 and optionally with liquid feedstock 14. Slurry catalyst is fed to the reactor, either directly 16a or pre-combined with the liquid feedstock 16b before being fed to the reactor. The hydroconversion process within the reactor produces gas and liquid products 18. A product recycle feed may also be directly fed to the hydroconversion reactor 22a and/or pre-combined with the liquid feedstock 22b before being fed to the reactor. Liquid product containing slurry catalyst and other solids is removed from the reactor in stream 24 and fed to a solid-liquid separation stage 20. Solids 26 are separated from the liquid product, with the liquid recycled to the reactor 22a and/or the liquid feedstock 22b before being fed to the reactor.

### EXAMPLES

Experimental studies and reactor case study simulations were carried out to assess the performance of direct biomass feed slurry hydroprocessing. Pulverized wood flour was used as a representative solid biomass direct injection feedstock and an autoclave reactor was used to assess slurry hydrocracker performance. Case studies were simulated based on kinetics developed from hydroconversion studies and hydroconversion process simulations.

### Example 1—Solid Biomass Pore Characterization and Slurry Characterization

Pulverized wood flour was used as a representative solid biomass feedstock. The incipient (wet) pore volume was measured by incipient wetness impregnation method. About five grams of wood flour was weighed in a 50-ml beaker. Deionized water was gradually peptized into the wood flour. Capillary action drew the water into the pores of wood flour until all pores were saturated. Any excess liquid could be observed visually when the absorption capacity is reached. The wet pore volume is calculated by dividing the total volume of water absorbed in the pores by the total weight of the wood flour. The mercury intrusion pore volume was measured per ASTM D4284 in a Mercury Intrusion Porosimeter (Micromeritics). This test determines the intrusion pore volume distributions of a solid by the method of mercury intrusion porosimetry. The range of the applicable pore diameters is controlled by mercury intrusion pressure. The range is typically between apparent pore entrance diameters of about 0.003 micron (3 nm) to 100 microns.

Table 1 provides pore characterization information determined using incipient wetness and mercury intrusion techniques. The wood flour had a wet pore volume of 1.39 cc/g as measured by incipient wetness and 1.68 cc/g as measured by the mercury intrusion method.

TABLE 1
Wood Flour Biomass Pore Volume Characterization

| Pore Volume Method | Incipient Wetness | Mercury Intrusion |
|---|---|---|
| Pore Volume, cc/g | 1.39 | 1.68 |
| Liquid | Vacuum Residue | Vacuum Residue |
| Liquid Density, g/cc | 1.04 | 1.04 |
| Liquid to Fill Pore, g/g | 1.44 | 1.74 |
| Solid wt. % at Incipient | 41.0% | 36.5% |
| Wetness | | |

As shown in Table 1, the incipient wetness solids content for a combined solid biomass and liquid feedstock using vacuum residue was 36.5 wt. % by mercury intrusion and 41 wt. % by incipient wetness, indicating only low levels of solid biomass are possible in slurry compositions.

Wood flour and FCC Medium Cycle Oil (MCO) mixtures were also assessed for suitability in forming slurries. Varying wood flour contents in FCC MCO were prepared. Mixtures having <20 wt. % of wood flour provided a slurry showing good flow behavior. At 30 wt. % wood flour, the resulting slurry showed good flow behavior with free liquid observed right after the mixture was prepared. Within 1 hour, the MCO permeated into the wood flour pores or was trapped in external nooks and crannies. No free liquid was evident visually and the resulting slurry flow behavior was similar to a sludge. With increasing solid content, e.g., >40%, the mixture became partially wetted solids.

### Example 2—Hydroconversion of Solid Biomass and Liquid Feedstock (Vacuum Resid and FCC Slurry Oil)

100 g of pulverized wood as described in Example 1 was added into an autoclave reactor with liquid (vacuum resid and FCC slurry oil) and 2000 ppm of dispersed molybdenum sulfide catalyst, a pre-sulfided slurry catalyst containing 5 wt. % active molybdenum, as described in U.S. Pat. Nos. 8,802,586 and 9,040,446. It was processed in the autoclave reactor at 835° F. A low flow hydrogen feed was maintained during the reaction with the reactor pressure kept constant at 2500 psig. The abundant hydrogen and gas products were vented throughout the testing. After two hours, the reactor was cooled down. The overhead product was collected from a knock-out pot downstream of the reactor, while the heavy liquid and solid product slurry were collected from the reactor. The overhead product had two layers, with the bottom aqueous layer produced mainly from hydrodeoxygenation of wood, and a liquid oil layer of light products from the hydroconversion of biomass and hydrocarbon feedstock. The reactor slurry contained high boiling point product, catalyst, and coke. The solids from the slurry phase were separated by filtration and analyzed. The conversion of biomass was calculated as follows:

Biomass Conversion=1−(Weight of Coke from Biomass)/(Weight of Biomass Feed)

At the end of the trial, 1.4 g of solids were collected that originated from the wood flour. The corresponding biomass conversion was 98.6%.

### Example 3—Simulation of Solid Biomass and Liquid Feedstock (Vacuum Resid) Hydroconversion

A case study with 100 cubic meter reactor was simulated based on kinetics developed from hydroconversion studies and hydroconversion process simulations. Pulverized wood flour as described in Example 1 was used as the solid biomass and vacuum resid (VR) was used as a liquid feedstock in the simulation. Molybdenum octoate containing 15 wt. % of molybdenum was used as the simulation catalyst. The VR and catalyst were premixed and pumped into the reactor. Solid feedstock was added through the reactor top (e.g., with a screwfeeder). Reactor process conditions included a temperature of 805° F. and a pressure of 1500 psig. Process feedrates included separate feeds of pulverized wood flour at 55.17 MTPH (metric ton per hour), VR liquid feedstock at 8.83 MTPH, and hydrogen (net consumption) at 4.10 MTPH. 300 wppm Mo/Feed molybdenum sulfide catalyst was used. The feed composition and product yields are shown in Table 2.

TABLE 2
Feed (MTPH)

| | |
|---|---|
| Wood | 55.17 |
| VR | 8.83 |
| Catalyst | 0.13 |
| H₂ Consumed | 4.10 |
| Total | 68.23 |

Product (MTPH)

| | |
|---|---|
| H₂O | 21.92 |
| CO | 1.43 |
| CO₂ | 5.41 |
| C1 | 2.96 |
| C2 | 1.68 |
| C3 | 1.65 |
| C4 | 1.32 |

| | | |
|---|---|---|
| C5-350° | F. | 14.16 |
| 350-680° | F. | 8.42 |
| >680° | F. | 8.28 |

| | |
|---|---|
| Solid (Catalyst & Coke) | 0.76 |
| H₂S | 0.33 |
| NH₃ | 0.10 |
| Total | 68.23 |

### Example 4—Simulation of Solid Biomass and Liquid Feedstock (Pyrolysis Oil) Hydroconversion

A further case study with the 100 cubic meter reactor of Example 2 was simulated with wood pyrolysis oil (PY oil) as the liquid feedstock such that the renewable content in the feed was essentially 100%. The slurry catalyst of Example 2 was used, a pre-sulfided catalyst containing 5 wt. % active molybdenum, as described in U.S. Pat. Nos. 8,802,586 and 9,040,446. A catalyst dosage of 500 wppm in total feed in terms of active molybdenum was used in the simulation. The wood pyrolysis oil and catalyst were pumped into the reactor separately due to their immiscibility. Solid feedstock was added from the reactor top (e.g., using a screwfeeder). Reactor process conditions included a temperature of 750° F.—and a pressure of 2500 psig. Process feedrates included pulverized wood flour at 52.41 MTPH (metric ton per hour), wood PY oil liquid carrier (feedstock) at 26.21 MTPH, and hydrogen (net consumption) at 4.34 MTPH. 300 wppm Mo/Feed molybdenum sulfide catalyst was used. The feed composition and product yields are shown in Table 3.

TABLE 3
Feed (MTPH)

| | |
|---|---|
| Wood | 52.41 |
| Pyrolysis Oil | 26.21 |
| Catalyst | 0.47 |
| H₂ Consumed | 5.62 |
| Total | 84.72 |

Product (MTPH)

| | |
|---|---|
| H₂O | 31.23 |
| CO | 2.04 |
| CO₂ | 7.70 |
| C1 | 4.01 |
| C2 | 2.28 |
| C3 | 2.28 |
| C4 | 1.81 |

| | | |
|---|---|---|
| C5-350° | F. | 16.41 |
| 350-680° | F. | 8.32 |
| >680° | F. | 7.48 |

| | |
|---|---|
| Solid (Catalyst & Coke) | 1.06 |
| H₂S | 0.16 |
| NH₃ | 0.11 |
| Total | 84.72 |

### Example 5—Simulation of Solid Biomass Hydroconversion without Liquid Feedstock

Another case study with the 100 cubic meter reactor of Example 3 was simulated to illustrate the benefit of direct solid biomass injection without a liquid feed. Unlike the use of slurry feeds, i.e., feeds containing a liquid feedstock, direct solid injection does not require any liquid feedstock as a carrier for the solid feedstock. Applicants have found that product formed from solid feedstock includes liquid that can be used to disperse catalyst and coke in the slurry reactor, thereby eliminating the need for liquid feedstock use.

In this example, no liquid feedstock was added. The feed contained only solid feedstock and catalyst. To keep more product in the liquid phase, the reactor operated at a relatively low 750° F. temperature and a pressure of 2500 psig. The slurry catalyst of Example 2 was used, a pre-sulfided catalyst containing 5 wt. % active molybdenum, as described in U.S. Pat. Nos. 8,802,586 and 9,040,446. A catalyst dosage of 500 wppm in total feed in terms of active molybdenum was used in the simulation. The reactor slurry phase contained liquid product, catalyst and coke, with a solids content of 24.8 wt. % based on process simulation. The feed composition and product yields are shown in Table 4.

TABLE 4
Feed (MTPH)

| | |
|---|---|
| Solid | 56.00 |
| Liquid | 0.00 |
| Cat | 0.56 |
| H₂ Consumed | 3.94 |
| Total | 60.50 |

Product (MTPH)

| | |
|---|---|
| H₂O | 22.24 |
| CO | 1.46 |
| CO₂ | 5.49 |
| C1 | 2.86 |
| C2 | 1.62 |
| C3 | 1.62 |
| C4 | 1.29 |

| | | |
|---|---|---|
| C5-350° | F. | 11.69 |
| 350-680° | F. | 5.99 |
| >680° | F. | 5.47 |

| | |
|---|---|
| Solid (Catalyst & Coke) | 0.77 |
| H₂S | 0.11 |
| NH₃ | 0.08 |
| Total | 60.50 |

The foregoing results demonstrate that useful products including renewable fuel grade products may be produced from direct feeding of solid biomass to a slurry hydroconversion process. High solid biomass feed content is possible, including up to 100% renewable feed content (e.g., with recycle or with liquid renewable feedstock). Prior art processes requiring the use of a liquefaction process step to pre-process the biomass is not required. Any concerns related to instability in intermediate liquefaction products should therefore be reduced as should be any concerns related to high-TAN (total acid number) content. In addition, the use of heavy oil feedstock such as vacuum resid (VR) is possible, e.g., as a liquid carrier (feedstock), without apparent aromaticity limitations.

For the avoidance of doubt, the present disclosure is directed to the subject-matter described in the following numbered paragraphs:

1. A direct biomass hydroconversion process, which is useful for producing renewable fuels, the process comprising:
separately feeding a solid biomass feedstock and a liquid feedstock to a slurry hydroconversion reactor; wherein the slurry hydroconversion reactor comprises a slurry hydroconversion catalyst;
contacting the solid biomass feedstock and the liquid feedstock with the slurry hydroconversion catalyst for a sufficient time under hydroconversion process conditions in the presence of hydrogen to convert the solid biomass feedstock and the liquid feedstock to hydroconversion product; and
withdrawing hydroconversion product from the reactor;
wherein, the solid biomass feedstock is directly fed to the slurry hydroconversion reactor and is provided as a raw biomass feedstock containing biomass components that have not been chemically processed or modified prior to being directly fed to the slurry hydroconversion reactor.

2. The process of paragraph 1, wherein the process provides a renewable fuel or a hydroconversion product useful to make a renewable fuel.

3. The process of paragraph 1 or paragraph 2, wherein the slurry hydroconversion catalyst or a precursor thereof is separately fed to the hydroconversion reactor, or is combined with the liquid feedstock and the combination fed to the hydroconversion reactor.

4. The process of any one of paragraphs 1-3, wherein the solid biomass feedstock is least about 10 wt. %, or 20 wt. %, or 30 wt. %, or 40 wt. %, or 50 wt. %, or 60 wt. %, or 70 wt. %, or 75 wt. %, or 80 wt. % of the total of the biomass and liquid feedstocks separately fed to the hydroconversion reactor.

5. The process of any one of paragraphs 1-4, wherein the liquid feedstock comprises a heavy boiling point component having a boiling point of at least about 800° F., and/or wherein the liquid feedstock is selected from vacuum gas oil, atmospheric resid, vacuum resid, FCC heavy cycle oil or decanted oil, FCC medium cycle oil, hydrocracker unconverted oil, or a combination thereof, optionally, wherein the liquid feedstock further comprises a renewable feedstock selected from plastic and/or wood pyrolysis oil, lipid, vegetable oil, or a combination thereof.

6. The process of any one of paragraphs 1-5, wherein the liquid feedstock comprises the heavy boiling point component having a boiling point of at least about 800° F. in an amount of up to about 50 wt. %, or 40 wt. %, or 30 wt. %, or 20 wt. %, or 10 wt. %, or in the range from about 10-50 wt. %, or 10-40 wt. %, or 10-30 wt. %, or 20-30 wt. %.

7. The process of any one of paragraphs 1-6, wherein a liquid product is recycled to the hydroconversion reactor.

8. The process of any one of paragraphs 1-7, wherein the solid biomass feedstock comprises a solid biomass component selected from wood or wood mill byproduct, tree leaves, grass, algae, crop byproduct, municipal solid waste, or a combination thereof, optionally, wherein the solid biomass component is ground, pulverized, chipped or in a particulate, pellet, powder, shaving, chip, dust, or pulverized form, or a combination thereof.

9. The process of any one of paragraphs 1-8, wherein the slurry hydroconversion catalyst is in the form of fine particulates dispersed within the reactor liquid reaction medium and is a supported catalyst, an unsupported catalyst, or a combination thereof.

10. The process of any one of paragraphs 1-9, wherein the slurry hydroconversion catalyst is unsulfided or pre-sulfided before being added to the reactor, optionally dispersed within a hydrocarbon oil diluent, and wherein the slurry catalyst comprises a metal selected from Group VIB, Group VIII, or Group IIB of the Periodic Table, or a combination thereof.

11. The process of any one of paragraphs 1-10, wherein the slurry hydroconversion catalyst comprises an unsupported catalyst selected from molybdenum sulfide, iron sulfide, nickel sulfide, zinc sulfide, iron zinc, or a combination thereof.

12. The process of any one of paragraphs 1-11, wherein the slurry hydroconversion catalyst is provided in the form of a catalyst precursor selected from oil soluble Group VIB metal compounds, aqueous Group VIB metal compounds, aqueous Group VIB metal trisulfide suspension or colloid, or a combination thereof.

13. The process of any one of paragraphs 1-12, wherein the slurry hydroconversion catalyst comprises a supported catalyst wherein the support is selected from alumina, silica-alumina, zeolite, or a combination thereof.

14. The process of any one of paragraphs 1-13, wherein the slurry hydroconversion catalyst, the solid biomass feedstock, and hydrogen are fed to the hydroconversion reactor as separate feedstreams to the reactor or are pre-mixed in any combination before being fed to the reactor.

15. The process of any one of paragraphs 1-14, wherein the solid biomass feedstock fed to the slurry hydroconversion reactor undergoes hydrocracking, hydrogenation, hydrodeoxygenation, hydrodesulfurization, hydrodenitrogenization, hydrodemetallization, hydrodechlorination, hydrodecarboxylation, hydrodecarbonylation, hydrodearomatization, or a combination thereof.

16. The process of any one of paragraphs 1-15, wherein the hydroconversion process conditions include operation within a temperature range of about 650-950° F., a reactor pressure of about 300-3500 psig, an average residence time of from 10 min. to 5 hrs., and a space velocity of about 0.1 to 5.0, or 0.5 to 5.0, or 0.5 to 2.0 hr⁻¹, and, optionally, wherein liquid product and/or slurry catalyst is recycled to the slurry hydroconversion reactor.

17. The process of any one of paragraphs 1-16, wherein the coke yield is less than about 5 wt. %, or less than about 2 wt. %, or less than about 1 wt. % of the solid biomass fed to the process.

18. The process of any one of paragraphs 1-17, wherein the hydroconversion product includes a liquid hydrocarbon product having an oxygen content of less than about 3 wt. % or less than about 1 wt. %, and/or wherein the total acid number (TAN) is less than about 1.

The present disclosure is not to be limited in terms of the particular embodiments described in this application, which are intended as illustrations of various aspects. Many modifications and variations can be made without departing from its spirit and scope, as may be apparent. Functionally equivalent methods and systems within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, in some cases, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive.

Where permitted, all publications, patents and patent applications cited in this application are incorporated by reference herein in their entirety, to the extent such disclosure is not inconsistent with the present invention.

1. A direct biomass hydroconversion process, which is useful for producing renewable fuels, the process comprising:
separately feeding a solid biomass feedstock and a liquid feedstock to a slurry hydroconversion reactor; wherein the slurry hydroconversion reactor comprises a slurry hydroconversion catalyst;
contacting the solid biomass feedstock and the liquid feedstock with the slurry hydroconversion catalyst for a sufficient time under hydroconversion process conditions in the presence of hydrogen to convert the solid biomass feedstock and the liquid feedstock to hydroconversion product; and
withdrawing hydroconversion product from the reactor;
wherein, the solid biomass feedstock is directly fed to the slurry hydroconversion reactor and is provided as a raw biomass feedstock containing biomass components that have not been chemically processed or modified prior to being directly fed to the slurry hydroconversion reactor.

2. The process of claim 1, wherein the process provides a renewable fuel or a hydroconversion product useful to make a renewable fuel.

3. The process of claim 1, wherein the slurry hydroconversion catalyst or a precursor thereof is separately fed to the hydroconversion reactor, or is combined with the liquid feedstock and the combination fed to the hydroconversion reactor.

4. The process of claim 1, wherein the solid biomass feedstock is least about 10 wt. %, or 20 wt. %, or 30 wt. %, or 40 wt. %, or 50 wt. %, or 60 wt. %, or 70 wt. %, or 75 wt. %, or 80 wt. % of the total of the biomass and liquid feedstocks separately fed to the hydroconversion reactor.

5. The process of claim 1, wherein the liquid feedstock comprises a heavy boiling point component having a boiling point of at least about 800° F., and/or wherein the liquid feedstock is selected from vacuum gas oil, atmospheric resid, vacuum resid, FCC heavy cycle oil or decanted oil, FCC medium cycle oil, hydrocracker unconverted oil, or a combination thereof, optionally, wherein the liquid feedstock further comprises a renewable feedstock selected from plastic and/or wood pyrolysis oil, lipid, vegetable oil, or a combination thereof.

6. The process of claim 1, wherein the liquid feedstock comprises the heavy boiling point component having a boiling point of at least about 800° F. in an amount of up to about 50 wt. %, or 40 wt. %, or 30 wt. %, or 20 wt. %, or 10 wt. %, or in the range from about 10-50 wt. %, or 10-40 wt. %, or 10-30 wt. %, or 20-30 wt. %.

7. The process of claim 1, wherein a liquid product is recycled to the hydroconversion reactor.

8. The process of claim 1, wherein the solid biomass feedstock comprises a solid biomass component selected from wood or wood mill byproduct, tree leaves, grass, algae, crop byproduct, municipal solid waste, or a combination thereof, optionally, wherein the solid biomass component is ground, pulverized, chipped or in a particulate, pellet, powder, shaving, chip, dust, or pulverized form, or a combination thereof.

9. The process of claim 1, wherein the slurry hydroconversion catalyst is in the form of fine particulates dispersed within the reactor liquid reaction medium and is a supported catalyst, an unsupported catalyst, or a combination thereof.

10. The process of claim 1, wherein the slurry hydroconversion catalyst is unsulfided or pre-sulfided before being added to the reactor, optionally dispersed within a hydrocarbon oil diluent, and wherein the slurry catalyst comprises a metal selected from Group VIB, Group VIII, or Group IIB of the Periodic Table, or a combination thereof.

11. The process of claim 1, wherein the slurry hydroconversion catalyst comprises an unsupported catalyst selected from molybdenum sulfide, iron sulfide, nickel sulfide, zinc sulfide, iron zinc, or a combination thereof.

12. The process of claim 1, wherein the slurry hydroconversion catalyst is provided in the form of a catalyst precursor selected from oil soluble Group VIB metal compounds, aqueous Group VIB metal compounds, aqueous Group VIB metal trisulfide suspension or colloid, or a combination thereof.

13. The process of claim 1, wherein the slurry hydroconversion catalyst comprises a supported catalyst wherein the support is selected from alumina, silica-alumina, zeolite, or a combination thereof.

14. The process of claim 1, wherein the slurry hydroconversion catalyst, the solid biomass feedstock, and hydrogen are fed to the hydroconversion reactor as separate feedstreams to the reactor or are pre-mixed in any combination before being fed to the reactor.

15. The process of claim 1, wherein the solid biomass feedstock fed to the slurry hydroconversion reactor undergoes hydrocracking, hydrogenation, hydrodeoxygenation, hydrodesulfurization, hydrodenitrogenization, hydrodemetallization, hydrodechlorination, hydrodecarboxylation, hydrodecarbonylation, hydrodearomatization, or a combination thereof.

16. The process of claim 1, wherein the hydroconversion process conditions include operation within a temperature range of about 650-950° F., a reactor pressure of about 300-3500 psig, an average residence time of from 10 min. to 5 hrs., and a space velocity of about 0.1 to 5.0, or 0.5 to 5.0, or 0.5 to 2.0 hr⁻¹, and, optionally, wherein liquid product and/or slurry catalyst is recycled to the slurry hydroconversion reactor.

17. The process of claim 1, wherein the coke yield is less than about 5 wt. %, or less than about 2 wt. %, or less than about 1 wt. % of the solid biomass fed to the process.

18. The process of claim 1, wherein the hydroconversion product includes a liquid hydrocarbon product having an oxygen content of less than about 3 wt. % or less than about 1 wt. %, and/or wherein the total acid number (TAN) is less than about 1.
